(19) United States
(12) Patent Application Publication
(10) Pub. No.: US 2009/0265758 A1
(43) Pub. Date: Oct. 22, 2009

(54) ATTACH DETECTION WITH COATING PUF

(75) Inventor: Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/296,675

(22) PCT Filed: Apr. 5, 2007
(86) PCT No.: PCT/IB2007/051223

§ 371 Date: Oct. 10, 2008

(30) Foreign Application Priority Data
Apr. 11, 2006 (EP) 06112483.0

(51) Int. Cl. H04L 9/32

(52) U.S. Cl. 726/2

(57) ABSTRACT

The present invention relates to a method of authenticating a physical token (14) which provides measurable parameters, and a device (11) comprising a physical token (14) which provides measurable parameters for authentication. A basic idea of the invention is to utilize properties of a physical token (14) comprised in a device (11) to detect whether the device has been tampered with. In an enrolment phase, values of a plurality of physical parameters provided by the physical token are measured. This set of measured values is referred to as response data. Noise-correcting data, also referred to as helper data, is employed to provide noise-robustness to the response data in a secure way. Then, in an authentication phase, the parameter values are measured again, and the noise-correcting data is employed to derive verification data. The verification data is compared with the enrolment data and a determination is made whether the derived verification data corresponds to the enrolment data. If so, the physical token is considered to be authenticated.

The present invention relates to a method of authenticating a physical token which provides measurable parameters, and a device comprising a physical token which provides measurable parameters for authentication.

A Physical Uncloneable Function (PUF) is a structure used for creating a tamper-resistant environment in which parties may establish shared secrets and/or cryptographic material such as encryption keys. A PUF is a physical token to which an input—a challenge—is provided. When the challenge is provided to the PUF, it produces a random analog output referred to as a response. Because of its complexity and the physical laws it complies with, the token is considered to be ‘uncloneable’, i.e. unfeasible to physically replicate and/or computationally model. A PUF is sometimes also referred to as a Physical Random Function. A PUF can be substantially strengthened if it is combined with a control function. In practice, the PUF and an algorithm that is inseparable from the PUF are comprised within a tamper-resistant chip, a so-called controlled PUF (CPUF). The algorithm, which is implemented in hardware, software or a combination thereof, governs the input and output of the PUF. For instance, frequent challenging of the PUF is prohibited, certain classes of challenges are prohibited, the physical output of the PUF is hidden, only cryptographically protected data is revealed, etc.

A PUF can be used as a generator of cryptographic key material in that bit strings may be derived from the output of the PUF. An example of such a PUF is a 3D optical medium containing light scattering elements at random positions. An input—i.e. a challenge—to the optical medium can e.g. be angle of incidence of a laser beam that illuminates the PUF, and an output—i.e. a response—is a speckle pattern created by the light scattering elements as a result of a particular angle of incidence. This response may be detected with a camera and quantized into a cryptographic key. Another way of creating a PUF that may be used as a source of cryptographic key material is to cover an integrated circuit (IC) with a coating in which dielectric particles are interspersed. These particles typically have different dielectric constants and more or less random shapes, dimensions and locations due to production processes. Sensor elements are arranged at a top metal layer of the IC to locally measure capacitance values at different coating positions. In this example, the coating itself constitutes a physical uncloneable function. As a result of the random nature of the dielectric particles, the measured capacitance values make excellent key material. The IC provided with a PUF in the form of a coating measures capacitances and converts the capacitance values into bit strings from which the cryptographic keys are derived.

“Protecting Devices by Active Coating” by Dr. Reinhard Posch, Technische Universität GRAZ, AUSTRIA, published in Journal of Universal Computer Science, vol. 4, no. 7 (1998), 652-668, © Springer Pub. Co., discloses a method of utilizing random properties of a coating material used e.g. in a smart card or in a covering material of some other secure hardware device to detect tampering of the device. In the method disclosed, the coating is assumed to be of a material that has an electrically measurable property (e.g. resistance or capacitance). Because of non-reproducible and random properties of the material, the electrical measurable property can be sensed and cryptographic key material can be created from sensed values. Tampering with this type of coating leads to a change in the cryptographic keys, and tampering thus destroys such keys.

Physical attacks on integrated circuits (IC) pose a major security problem to an ever increasing extent and chip manufacturers commonly cover their ICs with protective coatings. Attackers continuously develop techniques to circumvent countermeasures of the chip manufacturers. These techniques range from etching to light and ion-beam attacks. There is hence a desire to develop and improve approaches for impeding security attacks on chips such as ICs.

An object of the present invention is to solve the above mentioned problems in the prior art and provide a way to detect tampering of a device.

This object is attained by a method of authenticating a physical token which provides measurable parameters in accordance with claim 1, and a device comprising a physical token which provides measurable parameters for authentication in accordance with claim 10.

In a first aspect of the invention, there is provided a method comprising the steps of measuring values of a plurality of said parameters provided by a physical token and processing the measured values with noise-correcting data to derive a set of verification data. Further, the method comprises the steps of comparing the verification data with enrolment data derived from values of said plurality of parameters measured during an enrolment of the physical token and determining whether the derived verification data corresponds to the enrolment data, wherein the physical token is considered to be authenticated if there is correspondence between the verification data and the enrolment data.

In a second aspect of the invention, there is provided a device comprising means for measuring values of a plurality of said parameters provided by a physical token and means for processing the measured values with noise-correcting data to derive a set of verification data, comparing the verification data with enrolment data derived from the noise-correcting data and values of said plurality of parameters measured during an enrolment of the physical token and determining whether the derived verification data corresponds to the enrolment data, wherein the device is considered to be authenticated if there is correspondence between the verification data and the enrolment data.

A basic idea of the invention is to utilize properties of a physical token comprised in a device to detect whether the device has been tampered with.

In an enrolment phase, values of a plurality of physical parameters provided by the physical token are measured. For instance, the device for which tampering should be detected comprises an integrated circuit (IC) having sensor elements, and a physical token in the form of a coating covering the IC. The sensor elements arranged at the IC are arranged to measure a plurality of physical parameters provided by the coating, such as capacitance at different coating positions. Thus, capacitance values are typically measured at N different positions of the coating, which result in a set R of measured values R₀, R₁, . . . , R_{N-1}. This set of measured values is referred to as response data. Noise-correcting data, also referred to as helper data, is employed to provide noise-robustness in a secure way. A response attained during enrolment is not necessarily identical to a (theoretically identical) response attained during an authentication phase. When a physical property is measured, such as a response, there is always random noise present in the measurement, so the outcome of a quantization process to convert a measured analog property into digital data will differ for different measurements of the same physical property. In order to provide robustness to noise, helper data is derived and stored during enrolment. The helper data will be used during authentication to achieve noise robustness. Helper data is considered to be public data and only reveals a negligible amount of information about secret enrolment data derived from the response data.

In an exemplifying helper data scheme, the helper data Wand enrolment data S are based on response data R of a physical token via some appropriate function F_{G}, such that (W, S)=F_{G}(R). The function F_{G} might be a randomized function which enables generation of many pairs (W, S) of helper data Wand enrolment data S from one single set R of response data. This allows the enrolment data S (and hence also the helper data w) to be different for different enrolment authorities. The derived helper data and enrolment data are then stored in the device in which the physical token is implemented. The device comprises a microprocessor or some other appropriate device with computing capabilities, as well as storage means. Preferably but not necessarily, the enrolment data is cryptographically protected by the microprocessor before being stored.

Then, in an authentication phase, capacitance values are measured, which results in another set R of measured values R′₀, R′₁, . . . , R′_{N-1}. The helper data is, in the enrolment phase, chosen such that when a delta-contracting function G is applied to the response data R=R₀, R₁, . . . , R_{N-1} and the helper data W=W₀, W₁, . . . , W_{N-1}, the outcome equals the enrolment data S=S₀, S₁, . . . , S_{N-1}. The delta-contracting function has the characteristic that it allows the choice of an appropriate value of the helper data such that any value of data which sufficiently resembles the response results in the same output value, i.e. data which is identical to the enrolment data. As a consequence, G(R, W)=G(R′, W)=S, if R′ resembles R to a sufficient degree. Hence, during authentication, a noisy response R′ will, together with the helper data W, result in verification data S′=G(R′, W) which is identical to the enrolment data S. The helper data is arranged such that no information is revealed about the enrolment data. In case the enrolment data was cryptographically protected in the device, the microprocessor of the device also cryptographically protects the verification data S′ in the authentication phase. Once the enrolment data and the verification data have been cryptographically protected in the device, the resulting protected data can be safely processed outside the device.

In the authentication phase, the verification data S′ is compared with the enrolment data S and determination is made whether the derived verification data corresponds to the enrolment data. If so, the physical token is considered to be authenticated.

The present invention is advantageously employed for determining whether a device such as an integrated circuit has been attacked or tampered with. Typically, a physical attack on the device damages the protective coating. By damaging the coating (i.e. the physical token of the device), the properties of the coating have been modified, and the response of the coating at a given coating position has been altered. As a result, the response data derived in the authentication phase will differ from the response data derived in the enrolment data, and authentication of the device comprising the physical token will fail.

For instance, when an IC wishes to check whether it has been attacked, it performs a measurement of capacitance values at N coating positions (where a sensor is arranged at the respective location for measuring the capacitance), resulting in the measured values R′₀, . . . , R′_{N-1}. Then, the helper data W₀, . . . , W_{N-1} created during enrolment is employed to derive verification data S′₀, . . . , S′_{N-1}. Then, the IC computes S′=S′₀∥ . . . ∥S′_{N-1} and a hash value H(S′) (where ∥ denotes concatenation of data), i.e. the enrolment data is cryptographically protected by means of a hash function. However, it should be noted that a plaintext copy of the verification data S′ may be compared to a plaintext copy of the enrolment data S, in which case cryptographic protection need not be undertaken. Finally, the IC checks whether H(S)=H(S′). If there is correspondence, the IC decides that it has not been attacked, while if the hash values do not correspond to each other, one or more measured capacitance values differ from the corresponding values measured during enrolment. The IC then concludes that it has been tampered with and will act appropriately, for example go into a sleep mode or simply shut itself down. A capacitance value which has been measured during authentication by a given sensor and which differs with respect to a value measured by the same given sensor during enrolment most likely implies that the IC has been tampered with. Hence, the plurality N of measured capacitance values must fall within predetermined error-tolerance boundaries for the IC to be authenticated: the more sensitive the delta-contracting function G employed to derive S and S′, the more narrow the boundaries.

In an embodiment of the present invention, a cryptographic function in the form of a non-invertible function, e.g. a hash function, is applied to the verification data S′. Advantageously, both the enrolment phase and the authentication phase should be undertaken without revealing the secret data (i.e. the enrolment data as well as the verification data) derived from the coating capacitance values measured at the device. Hence, in case the secret data is to be exported from the device, the microprocessor of the device obscures the enrolment data in the enrolment phase by means of using a hash function, resulting in a hash value H(S). A hash function has the advantage of requiring a relatively small amount of processing power. At authentication, the verification data S′ is hashed, which results in H(S′). If a comparison shows that H(S)=H(S′), the device that comprises the physical token determines that it has not been tampered with and is thus authenticated.

Further, by applying a hash function to the secret data, as is described hereinabove, the hashed enrolment data H(S) and verification data H(S) can be safely processed outside the device, if necessary.

In a further embodiment, the enrolment data S is encrypted during enrolment, e.g. using symmetric or asymmetric encryption. Possibly, the verification data S′ is also encrypted in the authentication phase and the corresponding encrypted data sets E_{K}(S) and E_{K}(S′) are compared to each other. Alternatively, the encrypted enrolment data is decrypted, hashed and compared to a hashed copy of the verification data. If encryption is performed, data may advantageously be reused.

Further features of, and advantages with, the present invention will become apparent when studying the appended claims and the following description. Those skilled in the art realize that different features of the present invention can be combined to create embodiments other than those described in the following.

A detailed description of preferred embodiments of the present invention will be given in the following with reference made to the accompanying drawing, in which:

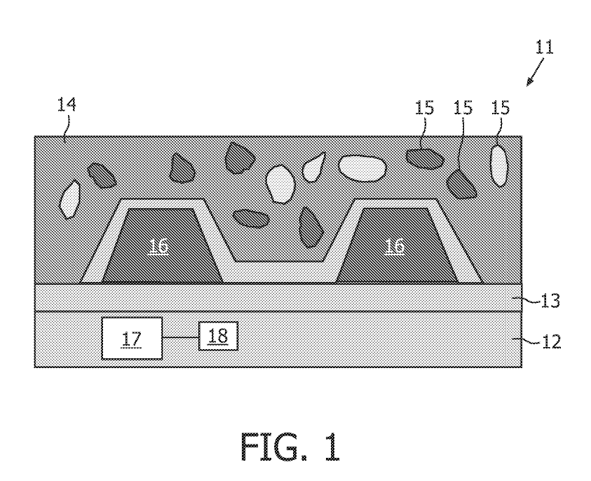

FIG. 1 shows a device comprising a physical token which provides measurable parameters for authentication according to an embodiment of the invention.

FIG. 1 shows a device comprising a physical token which provides measurable parameters for authentication according to an embodiment of the invention. The device 11 comprises an integrated circuit (IC) that consists of a semiconductor wafer 12, an insulating layer 13 and sensor elements 16. Further, the device comprises a physical uncloneable function (PUF) in the form of a coating 14 covering the IC. In the coating 14, dielectric particles 15 are interspersed. These particles typically have different dielectric constants and are of random size and shape. The sensor elements 16 are arranged at the insulating top metal layer 13 for locally measuring capacitance values at different coating positions. The device 11 is typically arranged with an input via which data can enter, and an output via which encrypted/decrypted (and possibly signed) data can be provided. Alternatively, the device 11 may receive encrypted data as input data and output decrypted data. The device 11 also comprises a microprocessor 17 or some other appropriate device with computing capabilities, such as an ASIC (Application Specific Integrated Circuit), an FPGA (Field Programmable Gate Array), a CPLD (Complex Programmable Logic Device), etc. The microprocessor is, for instance, employed to perform cryptographic operations and derive data sets from measured capacitance values. Further, the device 11 comprises storing means 18 and the microprocessor is typically arranged with an analog-digital converter (not shown) for converting measured analog capacitance values into digital bit strings for further processing. When performing steps of different embodiments of the method of the present invention, the microprocessor typically executes appropriate software that is downloaded to the device and stored in the storing means 18. A skilled person realizes that there exists a great number of combinations regarding inputting and/or outputting data which is encrypted/decrypted or processed in any other appropriate manner depending on the application in which the device is used.

Thus, in an embodiment of the present invention, a plurality of capacitance values R₀, R₁, . . . , R_{N-1} of the coating 14 are measured by the sensor elements 16 during enrolment of the device 11. Noise-correcting data Ware chosen by the device, and enrolment data S based on the response data R (which typically consists of concatenated capacitance values R₀∥R₁∥ . . . ∥R_{N-1}) of the coating and the noise-correcting data Ware derived by means of a function F_{G} applied at the microprocessor 17 such that (W, S)=F_{G}(R). Further, the microprocessor applies a hash function H to the enrolment data S resulting in a hash value H(S). The derived helper data Wand protected enrolment data H(S) are stored in the memory 18 of the device.

Then, in an authentication phase, where possible tampering of the device is detected, capacitance values are measured at the same sensor elements 18 as was used during enrolment, which results in another set R of measured values R′₀, R′₁, . . . , R′_{N-1}. As previously have been mentioned, the helper data is chosen during enrolment such that when a delta-contracting function G is applied to the enrolment response data R and the helper data W, the outcome equals the enrolment data S. The delta-contracting function has the characteristic that it allows the choice of an appropriate value of the helper data such that any value of data which sufficiently resembles the response results in the same output value, i.e. data which is identical to the enrolment data. As a consequence, G(R, W)=G(R′, W)=S, if response data R′ derived during authentication resembles response data R derived during enrolment to a sufficient degree. Hence, during authentication, a noisy response R′ will, together with the helper data W, result in verification data S′=G(R′, W) which is identical to the enrolment data S, if capacitive properties of the coating 14 have not been modified. The microprocessor 17 performs a hash of the verification data, resulting in H(S′). Then, the hashed verification data is compared to the hashed enrolment data. If H(S′)=H(S′), the device is considered not tampered with and may thus be authenticated.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of authenticating a physical token (14) which provides measurable parameters, the method comprising the steps of:
measuring values (R′0, . . . , R′N−1) of a plurality (N) of said parameters provided by the physical token (14);
processing the measured values (R′0, . . . , R′N−1) with noise-correcting data (W0, . . . , WN−1) to derive verification data (S′0, . . . , S′N−1);
comparing the verification data (S′0, . . . , S′N−1) with enrolment data (S0, . . . , SN−1) derived from the noise-correcting data and values (R0, . . . , RN−1) of said plurality (N) of parameters measured during an enrolment of the physical token; and
determining whether the derived verification data (S₀′, . . . , S′N−1) corresponds to the enrolment data (S0, . . . , SN−1), wherein the physical token is considered to be authenticated if there is correspondence between the verification data and the enrolment data.

2. The method according to claim 1, wherein the noise-correcting data (W) is derived during enrolment of the physical token (14).

3. The method according to claim 1, further comprising the step of:
cryptographically protecting said verification data (S′), wherein the cryptographically protected verification data is compared to cryptographically protected enrolment data and the physical token is considered to be authenticated if there is correspondence between the protected verification data and the protected enrolment data.

4. The method according to claim 3, wherein the data is protected by means of applying a non-invertible function.

5. The method according to claim 4, wherein the non-invertible function is a hash function.

6. The method according to claim 4, wherein the step of cryptographically protecting data comprises the step of:
applying a non-invertible function to said verification data (S′), wherein an output of the non-invertible function is compared to an output of said non-invertible function applied to the enrolment data, and the physical token is considered to be authenticated if there is correspondence between the two outputs of the non-invertible function.

7. The method according to claim 3, wherein the data is protected by means of encryption.

8. The method according to claim 1, further comprising the step of:
selecting the noise-correcting data (W) during enrolment of the physical token (14) such that the deriving of the enrolment data (S) based on measured values (R) of said plurality (N) of parameters and the noise-correcting data is performed by applying a function (FG) such that (W, S)=FG(R).

9. The method according to claim 8, further comprising the step of
storing the noise-correcting data (W) and the enrolment data (S) at the physical token (14).

10. A device (11) comprising a physical token (14) which provides measurable parameters for authentication of the device, the device further comprising:
means (16) for measuring values (R′0, . . . , R′N−1) of a plurality (N) of said parameters provided by the physical token (14);
means (17) for processing the measured values (R′0, . . . , R′N−1) with noise-correcting data (W0, . . . , WN−1) to derive verification data (S′0, . . . , S′N−1), comparing the verification data (S′0, . . . , S′N−1) with enrolment data (S0, . . . , SN−1) derived from the noise-correcting data and values (R0, . . . , RN−1) of said plurality (N) of parameters measured during an enrolment of the physical token and determining whether the derived verification data (S′0, . . . , S′N−1) corresponds to the enrolment data (S0, . . . , SN−1), wherein the device is considered to be authenticated if there is correspondence between the verification data and the enrolment data.

11. The device (11) according to claim 10, wherein the means (17) for processing further is arranged to apply a non-invertible function to said verification data (S′), wherein an output of the non-invertible function is compared to an output of said non-invertible function applied to the enrolment data, and the physical token (14) is considered to be authenticated if there is correspondence between the two outputs of the non-invertible function.

12. The device (11) according to claim 7, wherein the means (17) for processing further is arranged to select the noise-correcting data (W) during enrolment of the physical token (14) such that the deriving of the enrolment data (S) based on measured values (R) of said plurality (N) of parameters and the noise-correcting data is performed by applying a function (FG) such that (W, S)=FG(R).

13. The device (11) according to claim 10, further comprising: means (18) for storing the noise-correcting data (W) and the enrolment data (S).

14. The device (11) according to claim 10, further comprising an integrated circuit.

15. The device (11) according to claim 14, wherein the physical token (14) comprises a coating in which dielectric particles (15) are interspersed, said coating covering the integrated circuit.

16. A computer program product comprising computer-executable components for causing a device (11) to perform the steps recited in claim 1 when the computer-executable components are run on a processing unit (17) included in the device.
